(19) United States
(12) Patent Application Publication
(10) Pub. No.: US 2017/0114960 A1
(43) Pub. Date: Apr. 27, 2017

(54) LIQUEFIED GAS TREATMENT SYSTEM

(71) Applicant: HYUNDAI HEAVY INDUSTRIES CO., LTD., Dong-gu, Ulsan (KR)

(72) Inventors: Jin Kwang LEE, Changwon-si, Gyeongsangnam-do (KR); Sang Bong LEE, Jung-gu, Ulsan (KR)

(21) Appl. No.: 15/312,364

(22) PCT Filed: May 15, 2015
(86) PCT No.: PCT/KR2015/004930

§ 371 Date: Nov. 18, 2016

(30) Foreign Application Priority Data
May 19, 2014 (KR) 10-2014-0059794
May 13, 2015 (KR) 10-2015-0066470

(51) Int. Cl. F17C 13/02; F25J 1/00

(52) U.S. Cl. CPC F17C 13/02; F25J 1/0025; F17C 2227/0157; F17C 2250/0636; F17C 2265/034; F17C 2223/0161; F17C 2223/033; F17C 2221/033; F17C 2265/01; F17C 2265/03; F17C 2265/033; F17C 2265/037; F25J 2205/02; F25J 2290/62; F25J 2240/40

(57) ABSTRACT

The present invention relates to a liquefied gas treatment system in which a nitrogen control unit controls a content of nitrogen in a boil-off gas or a flash gas when a ratio of a nitrogen component of the flash gas is equal to or greater than a preset value. The efficiency of a boil-off gas compressor can be improved and the system can be stabilized by means of the nitrogen control unit.

### TECHNICAL FIELD

The present invention relates a liquefied gas treatment system.

### BACKGROUND ART

With recent technological advances, liquefied gas, such as liquefied natural gas or liquefied petroleum gas, which replaces gasoline or diesel, has recently been widely used.

Liquefied natural gas is gas that is converted into liquid form by cooling methane obtained by refining natural gas extracted from the gas field. The liquefied natural gas is a colorless, transparent liquid, and is a very excellent fuel that produces little pollution and has a high calorific value. On the other hand, liquefied petroleum gas is a fuel made by compressing gas, which is mainly composed of propane (C₃H₈) and butane (C₄H₁₀), extracted along with petroleum from oilfields, into liquid form at room temperature. Like the liquefied natural gas, the liquefied petroleum gas is colorless and odorless and has been widely used as household, commercial, industrial and automobile fuel.

The above-described liquefied gas is stored in a liquefied gas storage tank installed on the ground or on a ship that is a means of transportation sailing on the ocean. A volume of the liquefied natural gas is decreased by 1/600 by liquefaction, and a volume of propane and a volume of butane in the liquefied petroleum gas are decreased by 1/260 and 1/230, respectively, so that storage efficiency is high.

Such liquefied gas is supplied to and used by various sources of demand. In recent years, an LNG fuel supply method by which an LNG carrier drives an engine using LNG as a fuel has been developed. This method of using LNG as a fuel in an engine is also applicable to other ships.

However, the temperature and pressure of liquefied gas required by a source of demand, such as an engine, may be different from a state of liquefied gas stored in a liquefied gas storage tank. Therefore, the technique of controlling the temperature and pressure of liquefied gas, which is stored in liquid state, and supplying the liquefied gas to a source of demand has recently been researched and developed.

### DISCLOSURE

### Technical Problem

The present invention is conceived to solve the aforementioned problems. Accordingly, an object of the present invention is to provide a liquefied gas treatment system in which boil-off gas is pressurized to be supplied to a source of demand, a portion of the boil-off gas is expanded or decompressed to be re-liquefied, and boil-off gas for re-liquefaction is heat-exchanged with the boil-off gas, so that the re-liquefaction efficiency of the boil-off gas for re-liquefaction can be improved.

Another object of the present invention is to provide a liquefied gas treatment system in which, when mass flow of boil-off gas for driving a boil-off gas compressor is insufficient, at least a portion of flash gas generated in a re-liquefaction process of the boil-off gas is joined with the boil-off gas, and a ratio of nitrogen contained in the flash gas is controlled to be equal to or smaller than a set value, so that the efficiency of the boil-off gas compressor can be improved, and the system can be stabilized.

Still another object of the present invention is to provide a liquefied gas treatment system in which, when a ratio of nitrogen contained in flash gas is equal to or greater than a set value, at least a portion of the flash gas is controlled to be supplied to a liquefied gas storage tank, a gas combustion unit (GCU), or a nitrogen storage tank so as to maintain the ratio of the nitrogen to be equal to or smaller than the set value, so that environmental pollution due to discharging of the flash gas to the air can be prevented.

### Technical Solution

According to an aspect of the present invention, there is provided a liquefied gas treatment system including: a boil-off gas compressor configured to pressurize boil-off gas supplied from a liquefied gas storage tank; a boil-off gas liquefier configured to liquefy at least a portion of the boil-off gas pressurized by the boil-off gas compressor; a vapor-liquid separator configured to separate flash gas from the boil-off gas liquefied by the boil-off gas liquefier and mix at least a portion of the flash gas with the boil-off gas; and a nitrogen control unit configured to control a content of nitrogen in the boil-off gas or the flash gas, when a ratio of a nitrogen component of the flash gas is equal to or greater than a preset value.

Specifically, the liquefied gas treatment system may further include a boil-off gas heat exchanger configured to exchange heat between the boil-off gas pressurized by the boil-off gas compressor and the boil-off gas supplied from the liquefied gas storage tank.

Specifically, the liquefied gas treatment system may further include a flash gas heat exchanger configured to exchange heat between the boil-off gas pressurized by the boil-off gas compressor and the flash gas. The nitrogen control unit may include: a detector configured to analyze and detect components of the flash gas generated from the vapor-liquid separator; a distributor configured to distribute flow of the flash gas to allow at least a portion of the flash gas to be joined with the boil-off gas introduced into the boil-off gas compressor; and a nitrogen composition controller configured to control an operation of the distributor by checking whether a ratio of a nitrogen component in the components of the flash gas, which are received from the detector, is equal to or smaller than or is equal to or greater than a preset ratio value.

Specifically, the nitrogen composition controller may compare a current ratio value of the nitrogen component in the components of the flash gas, which are received from the detector, with the preset ratio value, when the current ratio value is equal to or smaller than the preset ratio value, control the operation of the distributor to allow the flash gas to be joined with the entire or at least a portion of the boil-off gas, and, when the current ratio value is equal to or greater than the preset ratio value, control the operation of the distributor to allow the nitrogen component separated from the flash gas to be supplied to the flash gas heat exchanger. When a ratio of nitrogen contained in the flash gas supplied from the vapor-liquid separator is equal to or greater than a preset ratio value, the distributor may separate the nitrogen in response to a control signal of the nitrogen composition controller to allow the flash gas in which the nitrogen is reduced to be joined with the boil-off gas, and supply the separated nitrogen to the flash gas heat exchanger.

Specifically, the liquefied gas treatment system may further include a flash gas heat exchanger configured to exchange heat between the boil-off gas pressurized by the boil-off gas compressor and the flash gas. The nitrogen control unit may include: a detector configured to measure and detect an internal pressure of the vapor-liquid separator; a distributor configured to distribute flow of the flash gas to allow at least a portion of the flash gas to be joined with the boil-off gas introduced into the boil-off gas compressor, and a nitrogen composition controller configured to control an operation of the distributor by checking whether the internal pressure of the vapor-liquid separator, which is received from the detector, is equal to or smaller than or is equal to or greater than a preset pressure value.

Specifically, the nitrogen composition controller may compare a current pressure value of the internal pressure of the vapor-liquid separator, which is received from the detector, with the preset pressure value, when the current pressure value is equal to or smaller than the preset pressure value, control the operation of the distributor to allow the entire or at least a portion of the flash gas to be joined with the boil-off gas, and, when the current pressure value is equal to or greater than the preset pressure value, control the operation of the distributor to allow the nitrogen component separated from the flash gas to be supplied to flash gas heat exchanger. When a ratio of nitrogen contained in the flash gas supplied from the vapor-liquid separator is equal to or greater than a preset ratio value, the distributor may separate the nitrogen in response to a control signal of the nitrogen composition controller to allow the flash gas in which the nitrogen is reduced to be joined with the boil-off gas, and supply the separated nitrogen to the flash gas heat exchanger.

Specifically, the nitrogen control unit may allow a portion of the rest of the flash gas to be discharged to a gas combustion unit.

Specifically, the liquefied gas treatment system may further include a flash gas heater configured to heat the flash gas discharged to the gas combustion unit using waste heat generated from the gas combustion unit. The nitrogen control unit may include: a detector configured to analyze and detect components of the flash gas generated from the vapor-liquid separator, a distributor configured to distribute flow of the flash gas to allow at least a portion of the flash gas to be joined with the boil-off gas introduced into the boil-off gas compressor, and a nitrogen composition controller configured to control an operation of the distributor by checking whether a ratio of a nitrogen component in the components of the flash gas, which are received from the detector, is equal to or smaller than or is equal to or greater than a preset ratio value.

Specifically, the nitrogen composition controller may compare a current ratio value of the nitrogen component in the components of the flash gas, which are received from the detector, with the preset ratio value, when the current ratio value is equal to or smaller than the preset ratio value, control the operation of the distributor to allow the flash gas to bejoined with the entire or at least a portion of the boil-off gas, and, when the current ratio value is equal to or greater than the preset ratio value, control the operation of the distributor to allow the nitrogen component separated from the flash gas to be supplied to the flash gas heat exchanger. When a ratio of nitrogen contained in the flash gas supplied from the vapor-liquid separator is equal to or greater than a preset ratio value, the distributor may separate the nitrogen in response to a control signal of the nitrogen composition controller to allow the flash gas in which the nitrogen is reduced to be joined with the boil-off gas, and supply the separated nitrogen to the flash gas heat exchanger.

Specifically, the liquefied gas treatment system may further include a flash gas heater configured to heat the flash gas discharged to the gas combustion unit using waste heat generated from the gas combustion unit. The nitrogen control unit may include: a detector configured to measure and detect an internal pressure of the vapor-liquid separator; a distributor configured to distribute flow of the flash gas to allow at least a portion of the flash gas to be joined with the boil-off gas introduced into the boil-off gas compressor, and a nitrogen composition controller configured to control an operation of the distributor by checking whether the internal pressure of the vapor-liquid separator, which is received from the detector, is equal to or smaller than or is equal to or greater than a preset pressure value.

Specifically, the nitrogen composition controller may compare a current pressure value of the internal pressure of the vapor-liquid separator, which is received from the detector, with the preset pressure value, when the current pressure value is equal to or smaller than the preset pressure value, control the operation of the distributor to allow the entire or at least a portion of the flash gas to be joined with the boil-off gas, and, when the current pressure value is equal to or greater than the preset pressure value, control the operation of the distributor to allow the nitrogen component separated from the flash gas to be supplied to flash gas heat exchanger. When a ratio of nitrogen contained in the flash gas supplied from the vapor-liquid separator is equal to or greater than a preset ratio value, the distributor may separate the nitrogen in response to a control signal of the nitrogen composition controller to allow the flash gas in which the nitrogen is reduced to be joined with the boil-off gas, and supply the separated nitrogen to the flash gas heat exchanger.

Specifically, the liquefied gas treatment system may further include a mixer provided upstream of the boil-off gas heat exchanger, the mixer being configured to mix flash gas recovered from the vapor-liquid separator with the boil-off gas supplied from the liquefied gas storage tank and supply the mixed gas to the boil-off gas heat exchanger.

### Advantageous Effects

In the liquefied gas treatment system according to the present invention, boil-off gas is pressurized to be supplied to a source of demand, and a portion of the boil-off gas is expanded or decompressed to be re-liquefied. In this case, boil-off gas for re-liquefaction is heat-exchanged with the boil-off gas. Accordingly, the re-liquefaction efficiency of the boil-off gas for re-liquefaction can be improved by cold heat of boil-off gas, and waste of the boil-off gas can be prevented, thereby saving fuel.

Also, in the liquefied gas treatment system according to the present invention, when mass flow of boil-off gas for driving a boil-off gas compressor is insufficient, at least a portion of flash gas generated in a re-liquefaction process of the boil-off gas is joined with the boil-off gas, and the nitrogen control unit controls a ratio of nitrogen contained in the flash gas to be equal to or smaller than a set value a predetermined mass flow is supplied to boil-off gas compressor, so that recycle control can be minimized, thereby improving driving efficiency. In addition, the ratio of nitrogen in the system can be properly controlled. Accordingly, the efficiency of the boil-off gas compressor can be improved, and the system can be stabilized.

Also, in the liquefied gas treatment system according to the present invention, when a ratio of nitrogen contained in flash gas is equal to or greater than a set value, the nitrogen control unit controls at least a portion of the flash gas to be supplied to the liquefied gas storage tank so as to maintain the ratio of the nitrogen to be equal to or smaller than the set value, so that the flash gas can be stored and treated in the liquefied gas storage tank. Accordingly, environmental pollution due to discharging of the flash gas to the air can be prevented, and boil-off gas can be well supplied by increasing internal pressure of the liquefied gas storage tank.

Also, in the liquefied gas treatment system according to the present invention, when mass flow of boil-off gas for driving a boil-off gas compressor is insufficient, at least a portion of flash gas generated in a re-liquefaction process of the boil-off gas is joined with the boil-off gas. When a ratio of nitrogen contained in the flash gas is equal to or greater than a set value, the nitrogen control unit controls at least a portion of the flash gas to be supplied to the source of consumption so as to maintain the ratio of the nitrogen to be equal to or smaller than the set value. In this case, the flash gas is heat-exchanged with boil-off gas for re-liquefaction by the flash gas heat exchanger, so that the re-liquefaction efficiency of the boil-off gas for re-liquefaction can be improved. In addition, the flash gas can be treated in the source of demand, and thus environmental pollution due to discharging of the flash gas to the air can be prevented.

Also, in the liquefied gas treatment system according to the present invention, when mass flow of boil-off gas for driving a boil-off gas compressor is insufficient, at least a portion of flash gas generated in a re-liquefaction process of the boil-off gas is joined with the boil-off gas. When a ratio of nitrogen contained in the flash gas is equal to or greater than a set value, the nitrogen control unit controls at least a portion of the flash gas to be supplied to the gas combustion unit so as to maintain the ratio of the nitrogen to be equal to or smaller than the set value. In this case, the flash gas is heated by a heater, and waste heat generated from the gas combustion unit using a heat source of the heater is utilized, so that the combustion efficiency of the flash gas and the energy efficiency due to the use of waste heat can be improved. In addition, the flash gas can be treated in the gas combustion unit, and thus environmental pollution due to discharging of the flash gas to the air can be prevented.

Also, in the liquefied gas treatment system according to the present invention, a content of nitrogen is detected based on a change in pressure through the measurement of an internal pressure of the vapor-liquid separator, and nitrogen is discharged based on the detected content of the nitrogen, so that accumulation of the nitrogen in the system can be prevented. Accordingly, re-liquefaction efficiency can be improved, and driving power of the boil-off gas compressor can be optimized.

### BRIEF DESCRIPTION OF THE DRAWINGS

FIG. 1 is a conceptual diagram of a liquefied gas treatment system according to a first embodiment of the present invention.

FIG. 2 is a graph illustrating power consumption with respect to mass flow of a boil-off gas compressor in a general liquefied gas treatment system.

FIG. 3 is a conceptual diagram of a liquefied gas treatment system according to a second embodiment of the present invention.

FIG. 4 is a conceptual diagram of a liquefied gas treatment system according to a third embodiment of the present invention.

FIG. 5 is a conceptual diagram of a liquefied gas treatment system according to a fourth embodiment of the present invention.

FIG. 6 is a conceptual diagram of a liquefied gas treatment system according to a fifth embodiment of the present invention.

FIG. 7 is a conceptual diagram of a liquefied gas treatment system according to a sixth embodiment of the present invention.

### MODE FOR THE INVENTION

Objects, specific advantages, and novel features of the invention will become more apparent from the following detailed description and exemplary embodiments when taken in conjunction with the accompanying drawings. In this specification, it should note that in giving reference numerals to elements of each drawing, like reference numerals refer to like elements even though like elements are shown in different drawings. In the following description, detailed explanation of known related functions and constitutions may be omitted to avoid unnecessarily obscuring the subject manner of the present invention.

Hereinafter, exemplary embodiments of the present invention will be described in detail with reference to the accompanying drawings.

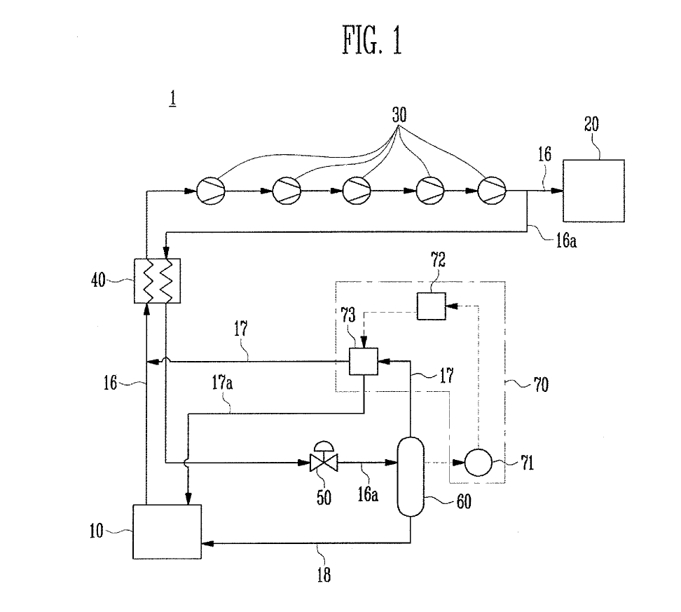

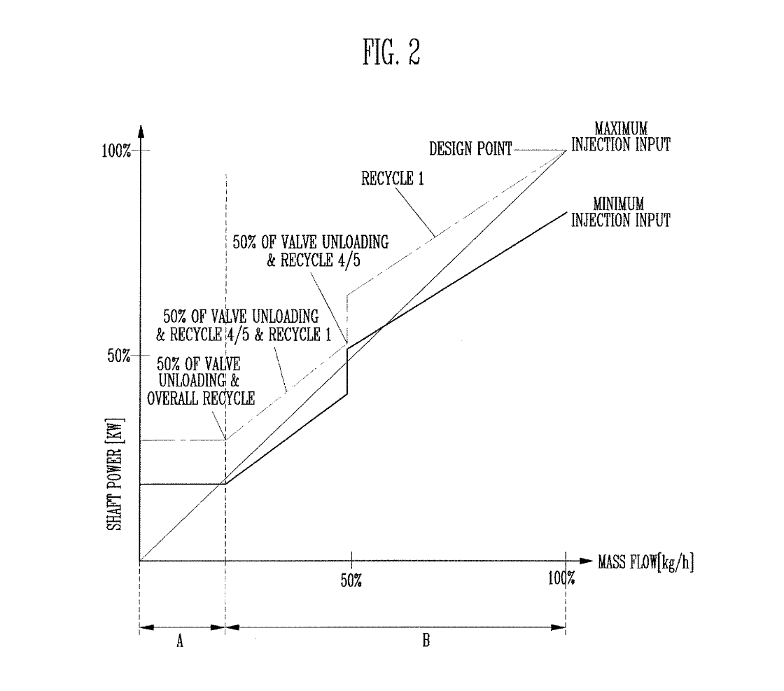

FIG. 1 is a conceptual diagram of a liquefied gas treatment system according to a first embodiment of the present invention. FIG. 2 is a graph illustrating power consumption with respect to mass flow of a boil-off gas compressor in a general liquefied gas treatment system.

As shown in FIG. 1, the liquefied gas treatment system 1 according to the first embodiment of the present invention includes a liquefied gas storage tank 10, a source 20 of demand, a boil-off gas compressor 30, a boil-off heat exchanger 40, a boil-off liquefier 50, a vapor-liquid separator 60, and a nitrogen control unit 70.

Throughout the specification, liquefied gas may cover all types of gas fuels generally stored in liquid state, such as LNG or LPG, ethylene, and ammonia. For convenience, gas fuel which is not in liquid state as a result of heating or pressurization may also be expressed as liquefied gas. This is identically applicable to boil-off gas. In addition, LNG may refer to natural gas (NG) in both liquid state and supercritical state, and boil-off gas may refer to liquefied boil-off gas as well as boil-off gas in gaseous state.

The liquefied gas storage tank 10 stores liquefied gas to be supplied to the source 20 of demand. The liquefied gas storage tank 10 is to store liquefied gas in liquid state. In this case, the liquefied gas storage tank 10 may be configured in the form of a pressure tank.

In this embodiment, boil-off gas generated in the liquefied gas storage tank 10 is supplied to the boil-off gas compressor 30 to be used in heating of the boil-off gas, or boil-off gas is vaporized and pressurized to be used as fuel of the source 20 of demand, thereby efficiently utilizing the boil-off gas.

Here, a forcing vaporizer (not shown) may be provided downstream of the liquefied gas storage tank 10. When the mass flow of the boil-off gas is insufficient, the forcing vaporizer may operate to increase the mass flow of the boil-off gas supplied to the source 20 of demand. That is, the forcing vaporizer may be provided upstream of a point at which it is joined with a gas recovery line 17 on a boil-off supply line 16, to vaporize the liquefied gas in the liquefied gas storage tank 10 and supply the liquefied gas in gaseous state to the boil-off gas compressor 30. A mixer (not shown) for mixing flash gas with the boil-off gas may be provided at a point at which the boil-off gas supply line 16 and the gas recovery line 17 are joined together.

The mixer may be provided upstream of the boil-off gas heat exchanger 40 on the boil-off gas supply line 16, to allow the boil-off gas supplied from the liquefied gas storage tank 10 to be introduced therein and allow flash gas recovered from the vapor-liquid separator 60, which will be described later, to be introduced therein. The mixer may be configured in the form of a pressure tank that forms a space in which the boil-off gas and the flash gas are stored. Here, the boil-off gas and the flash gas, which are mixed in the mixer, are supplied to the boil-off gas heat exchanger 40, which will be described later.

The source 20 of demand is driven through the boil-off gas supplied from the liquefied gas storage tank 10 and the flash gas to generate power. In this case, the source 20 of demand is a high pressure engine, and may be a gas fuel engine (e.g., MEGI).

In the source 20 of demand, as a piston (not shown) in a cylinder (not shown) moves in a reciprocating motion by combustion of liquefied gas, a crank shaft (not shown) connected to the piston may rotate, and a shaft (not shown) connected to the crank shaft may rotate correspondingly. Thus, as a propeller (not shown) connected to the shaft rotates while the source 20 of demand is driven, a ship may go forward or backward.

In this embodiment, the source 20 of demand may be an engine for driving the propeller. However, the source 20 of demand may be an engine for power generation or an engine for generating other types of power. That is, types of the source 20 of demand may not be particularly limited. However, the source 20 of demand may be an internal combustion engine that generates driving power by combustion of boil-off gas and flash gas.

The source 20 of demand may be supplied with the boil-off gas and flash gas pressurized by the boil-off gas compressor 30 to obtain driving power. States of the boil-off gas and the flash gas, which are supplied to the source 20 of demand, may vary depending on states required by the source 20 of demand.

The source 20 of demand may be a dual fuel engine to which boil-off gas or oil is selectively supplied without mixing the boil-off gas and oil with each other. Since boil-off gas or oil is selectively supplied to the dual fuel engine, two materials having different combustion temperatures are prevented from being mixed and supplied, so that deterioration in efficiency of the source 20 of demand can be prevented.

The boil-off gas supply line 16 that transfers the boil-off gas may be installed between the liquefied gas storage tank 10 and the source 20 of demand. The boil-off gas heat exchanger 40 and the boil-off compressor 30 may be installed on the boil-off gas supply line 16 to allow the boil-off gas to be supplied to the source 20 of demand. A boil-off return line 16a may be provided on the boil-off gas supply line 16 to branch off between the boil-off gas compressor 30 and the source 20 of demand. The boil-off gas heat exchanger 40, the boil-off gas liquefier 50, and the like may be provided on the boil-off return line 16a to allow the boil-off gas to be supplied to the vapor-liquid separator 60. Although not shown in FIG. 1, a forcing vaporizer, a mixer, and the like may be further provided on the boil-off gas supply line 16.

A fuel supply valve (not shown) may be provided on the boil-off gas supply line 16 and the boil-off return line 16a, so that supply of the boil-off gas can be controlled by adjusting opening of the fuel supply valve.

The boil-off gas compressor 30 pressurizes the boil-off gas generated from the liquefied gas storage tank 10. The boil-off gas compressor 30 may pressurize the boil-off gas, which is generated in and exhausted from the liquefied gas storage tank 10, and supply the pressurized boil-off gas to the boil-off gas heat exchanger 40 or the source 20 of demand.

The boil-off gas compressor 30 may be provided in plurality to perform multi-stage pressurization on boil-off gas. For example, five boil-off gas compressors 30 may be provided such that the boil-off gas is pressurized in five stages. The boil-off gas, which is pressurized in five stages, may be pressurized to a pressure ranging from 200 bar to 400 bar, to be supplied to the source 20 of demand through a boil-off gas supply line 16.

Here, the boil-off gas return line 16a may branch off between the boil-off gas compressor 30 and the source 20 of demand on the boil-off gas supply line 16, to be connected to the boil-off gas heat exchanger 40. In this case, a valve (not shown) may be provided on the boil-off gas supply line 16 at a point at which the boil-off gas return line 16a branches off to the boil-off gas heat exchanger 40. The valve may control mass flow of boil-off gas supplied to the source 20 of demand or mass flow of boil-off gas supplied to the boil-off gas heat exchanger 40 through the boil-off gas compressor 30. The valve may be a three way valve.

A boil-off gas cooler (not shown) may be provided between the plurality of boil-off gas compressors 30. When the boil-off gas is pressurized by the boil-off gas compressor 30, temperature may also increase as pressure increases. Hence, in this embodiment, the temperature of the boil-off gas may be again reduced by using the boil-off gas cooler. The number of boil-off gas coolers may be equal to the number of boil-off gas compressors 30. Each of the boil-off gas coolers may be provided downstream of each of the boil-off gas compressors 30.

Since the boil-off gas compressor 30 pressurizes the boil-off gas, the pressure of the boil-off gas may increase and its boiling point may increase, so that the pressurized boil-off gas can be easily liquefied at relatively high temperatures. Thus, in this embodiment, the boil-off gas can be easily liquefied by increasing the pressure of the boil-off gas by using the boil-off gas compressor 30.

The boil-off gas heat exchanger 40 may be provided between the liquefied gas storage tank 10 and the boil-off gas compressor 30 on the boil-off gas supply line 16, to perform heat exchange between the boil-off gas (boil-off gas for re-liquefaction) pressurized by the boil-off gas compressor 30 and the boil-off gas supplied from the liquefied gas storage tank 10. The boil-off gas heat-exchanged by the boil-off gas heat exchanger 40 may be supplied to the boil-off gas liquefier 50, which will be described later, or the boil-off gas compressor 30. That is, the boil-off gas for re-liquefaction, which is pressurized in multiple stages by the boil-off gas compressor 30 and recovered to the boil-off gas liquefier 50, and boil-off gas which is newly supplied from the liquefied gas storage tank 10, may be heat-exchanged by the boil-off gas heat exchanger 40.

The boil-off gas liquefier 50 is provided on the boil-off gas return line 16a, and liquefies at least a portion of boil-off gas for re-liquefaction, which is pressurized by the boil-off gas compressor 30 and heat-exchanged by the boil-off gas heat exchanger 40 by pressurizing or expanding the boil-off gas for re-liquefaction. For example, the boil-off gas liquefier 50 may decompress the boil-off gas for re-liquefaction to a pressure ranging from 1 bar to 10 bar. When the boil-off gas for re-liquefaction is liquefied and transferred to the vapor-liquid separator 60 or the liquefied gas storage tank 10, the boil-off gas for re-liquefaction may be decompressed up to a pressure of 1 bar. A cooling effect of the boil-off gas for re-liquefaction may be obtained during decompression.

Here, the boil-off gas for re-liquefaction, which is pressurized by the boil-off gas compressor 30, may be cooled by heat-exchange with the boil-off gas, which is supplied from the liquefied gas storage tank 10, in the boil-off gas heat exchanger 40. However, at the pressure of the boil-off gas for re-liquefaction may be maintained at a discharge pressure at which the boil-off gas for re-liquefaction is discharged from the boil-off gas compressor 30. In this embodiment, the boil-off gas for re-liquefaction may be cooled by decompressing the boil-off gas for re-liquefaction using the boil-off gas liquefier 50, so that the boil-off gas for re-liquefaction can be liquefied. As a range of pressure over which the boil-off gas for re-liquefaction is decompressed increases, the cooling effect of the boil-off gas for re-liquefaction may be increased. For example, the boil-off gas liquefier 50 may decompress the boil-off gas for re-liquefaction, which is pressurized to a pressure of 300 bar by the boil-off gas compressor 30, to a pressure of 1 bar.

The boil-off gas liquefier 50 may be configured as a Joule-Thomson valve. Alternatively, the boil-off gas liquefier 50 may be configured as an expanding mechanism (not shown). The Joule-Thomson valve may effectively cool boil-off gas for re-liquefaction through decompression such that at least a portion of the boil-off gas for re-liquefaction is liquefied. Here, the expanding mechanism may be configured as an expander (not shown).

On the other hand, the expander may be driven without using any separate power. Particularly, by using generated power to drive the boil-off gas compressor 30, efficiency of the liquefied gas treatment system 1 can be improved. For example, power transmission may be performed by gear connection or transfer after electrical energy conversion.

The vapor-liquid separator 60 separates vapor from the boil-off gas for re-liquefaction, which is decompressed or expanded by the boil-off gas liquefier 50. The boil-off gas for re-liquefaction may be separated into vapor and liquid by the vapor-liquid separator 60. The liquid may be supplied to the liquefied gas storage tank 10 through a liquid recovery line 18. Under control of the nitrogen control unit 70 which will be described later, the entire or majority of the vapor may be recovered as flash gas upstream of the boil-off gas compressor 30 through the gas recovery line 17, or a portion of the vapor may be supplied to the liquefied gas storage tank 10 through a gas treatment line 17a that branches off from the gas recovery line 17 to be stored and treated in the liquefied gas storage tank 10. A case where a portion of flash gas is stored and treated in the liquefied gas storage tank 10 through the gas treatment line 17a will be described later.

Here, the boil-off gas for re-liquefaction, which is supplied to the vapor-liquid separator 60, may be decompressed and cooled by the boil-off gas liquefier 50. For example, as the boil-off gas may be pressurized in multiple stages by the boil-off gas compressor 30, the pressurized boil-off gas may have a pressure ranging from 200 bar to 400 bar and a temperature of approximately 45 degrees C. The boil-off gas (boil-off gas for re-liquefaction), of which temperature increases to approximately 45 degrees C., may be recovered to the boil-off gas heat exchanger 40, exchange heat with the boil-off gas having a temperature of approximately −100 degrees C., which is supplied from the liquefied gas storage tank 10, and be cooled to a temperature of approximately −97 degrees C. to be supplied to the boil-off gas liquefier 50. In this case, the boil-off gas for re-liquefaction in the boil-off gas liquefier 50 may be cooled by decompression to have a pressure of approximately 1 bar and a temperature of approximately −162.3 degrees C.

As described above, in this embodiment, since the boil-off gas for re-liquefaction, which is supplied to the vapor-liquid separator 60, is decompressed by the boil-off gas liquefier 50, the boil-off gas for re-liquefaction may have a temperature lower than −162 degrees C., so that approximately 30 to 40% of the boil-off gas for re-liquefaction can be liquefied.

In addition, in this embodiment, the boil-off gas liquefied by the vapor-liquid separator 60 is recovered to the liquefied gas storage tank 10, and the flash gas generated from the vapor-liquid separator 60 is not thrown away but recovered to the boil-off gas compressor 30. Therefore, the boil-off gas and the flash gas can be pressurized by the boil-off gas compressor 30 and then supplied to the source 20 of demand.

When boil-off gas for re-liquefaction is separated into liquid and vapor, liquefied boil-off gas and generated flash gas may be recovered to the liquefied gas storage tank 10 and the boil-off gas compressor 30 through the liquid recovery line 18 and the vapor recovery line 17, respectively.

The liquid recovery line 18 may serve as a passage that is connected from the vapor-liquid separator 60 to the liquefied gas storage tank 10 to recover the boil-off gas in liquid state to the liquefied gas storage tank 10.

The vapor recovery line 17 may be connected from the vapor-liquid separator 60 to the boil-off gas supply line 16 upstream of the boil-off gas compressor 30 to recover flash gas upstream of the boil-off gas compressor 30. Thus, waste of the flash gas can be prevented. When a mixer is provided upstream of the boil-off gas heat exchanger 40 on the boil-off gas supply line 16, the vapor recovery line 17 may be connected to the mixer.

As described above, the flash gas may be cooled to −162.3 degrees C. by being decompressed by the boil-off gas liquefier 50. The flash gas and the boil-off gas having a temperature of −100 degrees C., generated in the liquefied gas storage tank 10, may be mixed at a point at which the boil-off supply line 16 and the vapor recovery line 17 meet each other to be introduced into the boil-off gas heat exchanger 40 as a boil-off gas having a temperature ranging from −110 degrees C. to −120 degrees C. (approximately −114 degrees C.).

Therefore, boil-off gas (boil-off gas for re-liquefaction) having a temperature of 45 degrees C., which is recovered along the boil-off gas return line 16a that branches off between the boil-off gas compressor 30 and the source 20 of demand and is connected to the boil-off gas heat exchanger 40, may be cooled by exchanging heat with boil-off gas having a temperature ranging from −110 degrees C. to −120 degrees C. in the boil-off gas heat exchanger 40. In comparison to when flash gas is not recovered (heat exchange between the boil-off gas for re-liquefaction having a temperature of 45 degrees C. and the boil-off gas having a temperature of −100 degrees C.), additional cooling of the boil-off gas for re-liquefaction may be implemented.

Thus, the boil-off gas for re-liquefaction, which is discharged from the boil-off gas heat exchanger 40 and introduced into the boil-off gas liquefier 50, may have a temperature of approximately −112 degrees C. lower than approximately −97 degrees C. of when flash gas is not circulated. If the boil-off gas is decompressed by the boil-off gas liquefier 50, the boil-off gas may be cooled to a temperature of approximately −163.7 degrees C. In this case, more boil-off gas for re-liquefaction may be liquefied by the boil-off gas liquefier 50 and recovered to the liquefied gas storage tank 10, as compared with when flash gas is not circulated.

Accordingly, in this embodiment, as gaseous boil-off gas is separated as flash gas from the boil-off gas for re-liquefaction, which is cooled by the boil-off gas liquefier 50, and supplied to the boil-off gas heat exchanger 40, temperature of the boil-off gas recovered from the boil-off gas compressor 30 to the boil-off heat exchanger 40 and the boil-off gas liquefier 50, is sufficiently reduced, so that liquefaction efficiency of the boil-off gas for re-liquefaction can be increased to 60% or higher.

In addition, in this embodiment, since flash gas mixed with boil-off gas as well as the boil-off gas from the liquefied gas storage tank 10 are introduced into the boil-off gas compressor 30, a predetermined mass flow is supplied to the boil-off gas compressor 30, so that driving efficiency can be improved.

As shown in the graph of FIG. 2, in a general boil-off gas compressor, shaft power may increase as mass flow increases in interval B. This means that more shaft power is required to compress a large mass flow of boil-off gas. In this case, the interval B may be an interval in which the mass flow of the boil-off gas is greater than a preset value (a reference value determining intervals A and B) which is determined by specifications and driving conditions of the boil-off gas compressor.

On the other hand, in interval A in which the mass flow of the boil-off gas introduced into the boil-off gas compressor is smaller than the preset value, shaft power is not reduced even when the mass flow of the boil-off gas decreases. This is because, when a predetermined volume of boil-off gas is not introduced into the boil-off gas compressor, surging may occur, and therefore, when the mass flow of the boil-off gas introduced into the boil-off gas compressor is smaller than the preset value, the volume of the boil-off gas introduced into the boil-off gas compressor is maintained at a constant value or higher by recycling a portion of the boil-off gas, thereby consuming shaft power for recycling.

However, in this embodiment, since flash gas as well as boil-off gas may be introduced into the boil-off gas compressor 30, even when the mass flow of the boil-off gas is reduced in interval A in which the mass flow of the boil-off gas is smaller than the preset value, the volume of the boil-off gas required by the boil-off gas compressor 30 may be satisfied by using the flash gas. Thus, shaft power can be reduced as the mass flow of the boil-off gas decreases. That is, in the boil-off gas compressor 30 of this embodiment, shaft power can be reduced in proportion to decrease in mass flow of the boil-off gas in interval A.

Accordingly, in this embodiment, when there is a small amount of the boil-off gas, recycle control of the boil-off gas compressor 30 is reduced by controlling the amount of the flash gas, so that required power can be reduced by low-load operation of the boil-off gas compressor 30.

The boil-off gas compressor 30 of this embodiment may consume more shaft power as the mass flow of the boil-off gas increases in interval B. This is because more shaft power is required to compress more amount of boil-off gas. However, in this embodiment, since circulation of flash gas is performed, re-liquefaction efficiency of the boil-off gas can be significantly improved regardless of increase in shaft power of the boil-off gas compressor 30 according to the mass flow of the boil-off gas.

As described above, in this embodiment, the boil-off gas, which is generated from the liquefied gas storage tank 10 by external heat penetration, is pressurized and supplied to the source 20 of demand, or the flash gas is circulated and pressurized together with the boil-off gas by the boil-off gas compressor 30 and supplied to the source 20 of demand, so that waste of the boil-off gas can be prevented, thereby saving fuel. In addition, the boil-off gas is additionally cooled using the flash gas, thereby maximizing liquefaction efficiency. By mixing the flash gas with the boil-off gas, more than a predetermined mass flow is supplied to the boil-off gas compressor 30, so that recycle control can be minimized, thereby improving driving efficiency.

However, since flash gas mixed with boil-off gas contains a large amount of nitrogen, when the boil-off gas mixed with the flash gas is introduced into the boil-off gas compressor 30, load of the boil-off gas compressor 30 may increase, and efficiency of the source 20 of demand may be reduced as a ratio of the nitrogen contained the boil-off gas supplied to the source 20 of demand increases. When the nitrogen is continuously accumulated, the entire system 1 may be unstabilized. Accordingly, in this embodiment, the ratio of nitrogen in the system is properly controlled through the nitrogen control unit 70 which will be described later, so that efficiency of the boil-off gas compressor can be improved, and the system can be stabilized.

The nitrogen control unit 70 may be installed on the vapor recovery line 17. When at least a portion of flash gas generated from the vapor-liquid separator 60 is mixed with boil-off gas of the boil-off gas supply line 16 through the vapor recovery line 17 in a case where the mass flow of boil-off gas for driving the boil-off gas compressor 30 is insufficient, the nitrogen control unit 70 may control a ratio of nitrogen contained in the flash gas to be a set value or less or control the mass flow of the flash gas mixed with the boil-off gas to be reduced, thereby preventing accumulation of the nitrogen in the liquefied gas treatment system 1. The nitrogen control unit 70 may be configured to include a detector 71, a nitrogen (N₂) composition controller 72, and a distributor 73.

The detector 71 may be provided in the vapor-liquid separator 60. The detector 71 may be a gas chromatography capable of directly analyzing components of flash gas generated from the vapor-liquid separator 60 or a nitrogen sensor capable of directly measuring a ratio of nitrogen in the flash gas.

Here, the detector 71 is provided in the vapor-liquid separator 60, and may be provided the vapor recovery line 17 upstream or downstream of the distributor 73 which will be described later.

The detector 71 may include a wired/wireless transmitting unit. The detector 71 may transmit the components of the flash gas, which are analyzed as described above, to the nitrogen composition controller 72, which will be described later, through a wired/wireless method.

The nitrogen composition controller 72 may include a wired/wireless transmitting unit provided between the detector 71 and the distributor 73 which will be described later. The nitrogen composition controller 72 may control an operation of the distributor 73, which will be described later, through a wired/wireless method by checking whether the ratio of a nitrogen component among the components of the flash gas, which are received from the detector 71, is equal to or smaller than or is equal to or greater than a preset ratio value.

Specifically, when a value obtained by analyzing compositions of flash gas is received from the detector 71, based on a preset ratio value obtained by creating a table by experiment with respect to influence, etc. on efficiency of the boil-off gas compressor 30 or stability of the system 1 according to ratio of nitrogen contained in the flash gas, the nitrogen composition controller 72 may compare a current ratio of a nitrogen component among the components of the flash gas, received from the detector 71, with the preset ratio value. When the ratio of the nitrogen contained in the flash gas, which is a current value, is equal to or smaller than the preset ratio value, the nitrogen composition controller 72 may control an operation of the distributor 73, which will be described later, such that the flash gas is joined with boil-off gas of the boil-off supply line 16 through the vapor recovery line 17. When the ratio of the nitrogen contained in the flash gas is equal to or greater than the preset ratio value, the nitrogen composition controller 72 may control an operation of the distributor 73, which will be described later, such that at least a portion of the flash gas is supplied to the liquefied gas storage tank 10, a gas combustion unit (not shown), a nitrogen storage tank (not shown), or the like through the vapor treatment line 17a that branches off from the gas recovery line 17.

The distributor 73, may be provided on the vapor recovery line 17, be connected to the liquefied gas storage tank 10 by the vapor treatment line 17a, and be controlled in response to a control signal of the nitrogen composition controller 72. The distributor 73 may distribute flow of flash gas such that at least a portion of the flash gas is joined with boil-off gas introduced into the boil-off gas compressor 30.

The distributor 73 may include a wired/wireless receiving unit for receiving a control signal from the nitrogen composition controller 72. The distributor 73 may be a three way valve or a nitrogen separator.

When a ratio of nitrogen contained in flash gas supplied from the vapor-liquid separator 60 is equal to or greater than a preset ratio value, the three way valve may be operated in response to a control signal of the nitrogen composition controller 72 to increase opening to the liquefied gas storage tank 10. Accordingly, a ratio of nitrogen in a mixed gas (boil-off gas and flash gas) circulating in the system 1 can be maintained to be equal to or smaller than a set value.

It will be apparent that, when the ratio of the nitrogen contained in the flash gas is equal to or smaller than the preset ratio value, the three way valve may allow the entire or at least a portion of the flash gas to be joined with the boil-off gas.

When a ratio of nitrogen contained in flash gas supplied from the vapor-liquid separator 60 is equal to or greater than a preset ratio value, the nitrogen separator may be operated in response to a control signal of the nitrogen composition controller 72 to separate the nitrogen such that the flash gas in which the ratio of nitrogen is reduced is joined with boil-off gas of the boil-off gas supply line 16 through the vapor recovery line 17, and the separated nitrogen is supplied to the liquefied gas storage tank 10, the gas combustion unit, the nitrogen storage tank, or the like through the vapor treatment line 17a. Accordingly, a ratio of nitrogen in a mixed gas (boil-off gas and flash gas) circulating in the system 1 can be maintained to be equal to or smaller than a set value.

It will be apparent that, when the ratio of the nitrogen contained in the flash gas is equal to or smaller than the preset ratio value, the nitrogen separator is not operated to separate the nitrogen contained in the flash gas but may allow the entire or at least a portion of the flash gas to be joined with the boil-off gas.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the liquefied gas storage tank 10, the gas combustion unit, the nitrogen storage tank, or the like.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 1, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

As described above, in this embodiment, as the ratio of nitrogen contained in flash gas is controlled to be equal to or smaller than the preset ratio value, the nitrogen having a predetermined mass flow or higher is supplied to the boil-off gas compressor 30, so that recycle control can be minimized, thereby improving driving efficiency. In addition, the ratio of nitrogen in the system 1 can be properly controlled. Accordingly, the efficiency of the boil-off gas compressor 30 can be improved, and the system 1 can be stabilized. When the ratio of nitrogen contained in flash gas is equal to or greater than the preset ratio value, at least a portion of the flash gas is controlled to be supplied to the liquefied gas storage tank 10 to maintain the ratio of the nitrogen to be equal to or smaller than the preset ratio value, so that the flash gas can stored and treated in the liquefied gas storage tank 10. Accordingly, environmental pollution due to discharging of the flash gas to the air can be prevented, and boil-off gas can be well supplied by increasing internal pressure of the liquefied gas storage tank 10.

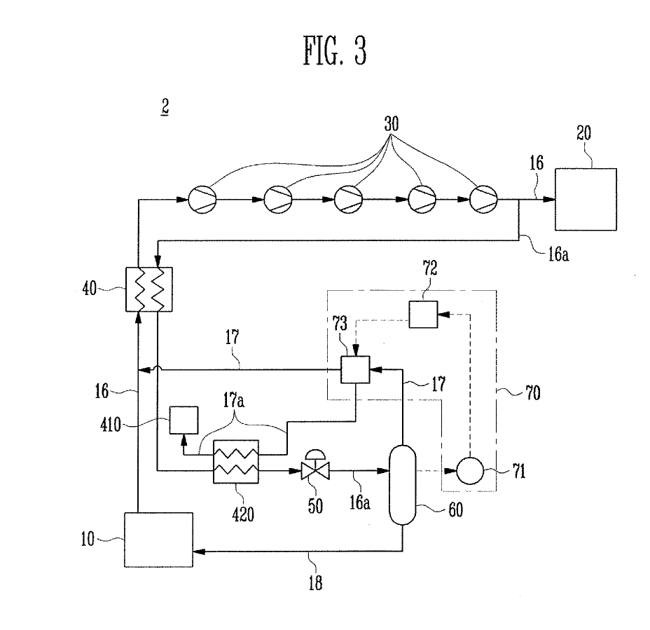

FIG. 3 is a conceptual diagram of a liquefied gas treatment system according to a second embodiment of the present invention.

As shown in FIG. 3, the liquefied gas treatment system 2 according to the second embodiment of the present invention includes a liquefied gas storage tank 10, a source 20 of demand, a boil-off gas compressor 30, a boil-off gas heat exchanger 40, a boil-off gas liquefier 50, a vapor-liquid separator 60, a nitrogen control unit 70, a source 410 of consumption, and a flash gas heat exchanger 420. In comparison to the first embodiment of the present invention, the second embodiment of the present invention has a different configuration of the source 410 of consumption and the flash gas heat exchanger 420, and the connection relationship of a vapor treatment line 17a related to this configuration is different. For convenience, components identical or corresponding to those of the first embodiment of the present invention are designated by like reference numerals, and their overlapping descriptions will be omitted.

The source 410 of consumption may be a gas combustion unit or a nitrogen storage tank. When a ratio of nitrogen contained in flash gas is equal to or greater than a preset ratio value, the source 410 of consumption may treat the flash gas supplied from the vapor-liquid separator 60 through the vapor treatment line 17a such that the ratio of the nitrogen is maintained to be equal to or smaller than the preset ratio value. In this case, the vapor treatment line 17a may be connected from a distributor 73 of the nitrogen control unit 70 to the source 410 of consumption, which is a gas combustion unit or a nitrogen storage tank.

The flash gas heat exchanger 420 may be provided on the vapor treatment line 17a and a boil-off gas return line 16a. Specifically, the flash gas heat exchanger 420 may be provided on the vapor treatment line 17a between the distributor 73 and the source 410 of consumption. The flash gas heat exchanger 420 may be provided on the boil-off gas return line 16a between the boil-off gas compressor 30 and the boil-off gas liquefier 50, between the boil-off gas heat exchanger 40 and the boil-off gas liquefier 50, or between the boil-off gas heat exchanger 40 and the boil-off gas compressor 30.

In the flash gas heat exchanger 420, boil-off gas for re-liquefaction, which has a relatively high temperature, is cooled using cold heat obtained from flash gas having a relatively low temperature, so that cooling efficiency of the boil-off liquefier 50 can be improved. Here, the boil-off gas heat exchanger 40 and the flash gas heat exchanger 420 are provided on the boil-off gas return line 16a upstream of the boil-off gas liquefied 50, so that liquefaction efficiency of the boil-off gas for re-liquefaction can be further improved.

In the above, when the source 410 of consumption is a gas combustion unit, the source 410 of consumption is to perform combustion treatment on flash gas containing nitrogen supplied from the distributor 73 (when the distributor is a three way valve) or flash gas containing a large amount of nitrogen (when the distributor is a nitrogen separator). In this case, when considering that flash gas generated from the vapor-liquid separator 60 may be decompressed and cooled by the boil-off gas liquefier 50 to be in low temperature state (e.g., −162.3 degrees C.) as described above, and the temperature for burning in the gas combustion unit is, for example, 40 degrees C., it is required to increase the temperature of the flash gas before the flash gas is supplied to the gas combustion unit.

In this embodiment, the flash gas heat exchanger 420 may heat flash gas up to the temperature for burning in the gas combustion unit before the flash gas is supplied to the gas combustion unit. In the flash gas heat exchanger 420, the flash gas having a relatively low temperature is heated using heat obtained from boil-off gas for re-liquefaction, which has a relatively high temperature, so that the combustion efficiency of the gas combustion unit can be improved.

The distributor 73 of the nitrogen control unit 70 may be a three way valve or a nitrogen separator. Since the second embodiment has a configuration partially different from that of the first embodiment, their functions may be different from each other.

That is, when a ratio of nitrogen contained in flash gas supplied from the vapor-liquid separator 60 is equal to or greater than a preset ratio value, the three way valve of the second embodiment may be operated in response to a control signal of a nitrogen composition controller 72 to increase opening to the flash gas heat exchanger 420 provided upstream of the source 410 of consumption. Accordingly, a ratio of nitrogen in a mixed gas (boil-off gas and flash gas) circulating in the system 2 can be maintained to be equal to or smaller than the preset ratio value, and the liquefaction efficiency of boil-off gas for re-liquefaction can be improved. In this case, the source 410 of consumption is preferably a gas combustion unit.

In addition, when a ratio of nitrogen contained in flash gas supplied from the vapor-liquid separator 60 is equal to or greater than a preset ratio value, the nitrogen separator of the second embodiment may be operated in response to a control signal of the nitrogen composition controller 72 to separate the nitrogen such that the flash gas in which the ratio of nitrogen is reduced is joined with boil-off gas of a boil-off gas supply line 16 through a vapor recovery line 17, and the separated nitrogen is supplied to the flash gas heat exchanger 420 provided upstream of the source 410 of consumption through the vapor treatment line 17a. Accordingly, a ratio of nitrogen in a mixed gas (boil-off gas and flash gas) circulating in the system 2 can be maintained to be equal to or smaller than the preset ratio value, and the liquefaction efficiency of boil-off gas for re-liquefaction can be improved. In this case, the source 410 of consumption is preferably a nitrogen storage tank.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the source 410 of consumption.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 2, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

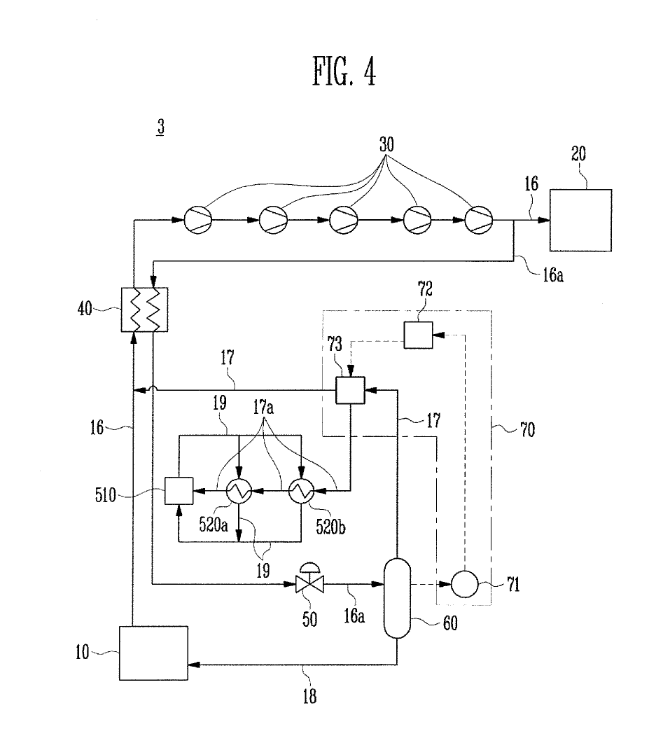

FIG. 4 is a conceptual diagram of a liquefied gas treatment system according to a third embodiment of the present invention.

As shown in FIG. 4, the liquefied gas treatment system 3 according to the third embodiment of the present invention includes a liquefied gas storage tank 10, a source 20 of demand, a boil-off gas compressor 30, a boil-off gas heat exchanger 40, a boil-off gas liquefier 50, a vapor-liquid separator 60, a nitrogen control unit 70, a gas combustion unit 510, and flash gas heaters 520a and 520b. In comparison to the first embodiment of the present invention, the first embodiment of the present invention has a different configuration of the gas combustion unit 510 and the flash gas heaters 520a and 520b, and the connection relationship of a vapor treatment line 17a related to this configuration is different. For convenience, components identical or corresponding to those of the first embodiment of the present invention are designated by like reference numerals, and their overlapping descriptions will be omitted.

When a ratio of nitrogen contained in flash gas is equal to or greater than a preset ratio value, the gas combustion unit 510 may perform combustion treatment on the flash gas supplied from the vapor-liquid separator 60 through the vapor treatment line 17a to maintain the ratio of the nitrogen to be equal to or smaller than the preset ratio value. In this case, the vapor treatment line 17a may be connected to a distributor 73 of the nitrogen control unit 70 to the gas combustion unit 510.

Here, the gas combustion unit 510 like when the source 410 of consumption of the second embodiment is a gas combustion unit, it is required to increase the temperature of the flash gas before the flash gas is supplied to the gas combustion unit 510.

The flash gas heaters 520a and 520b may be provided upstream of the gas combustion unit 510, specifically, on the vapor treatment line 17a between the distributor 73 and the gas combustion unit 510. The flash gas heaters 520a and 520b may heat flash gas up to temperature for burning in the gas combustion unit 510 before the flash gas is supplied to the gas combustion unit 510. Here, the flash gas heaters 520a and 520b may be configured by arranging a main heater 520a and an auxiliary heater 520b in series. As the main heater 520a and the auxiliary heater 520b are further provided, the combustion treatment efficiency of the gas combustion unit 510 can be further improved.

The flash gas heaters 520a and 520b may heat flash gas by using electrical energy as a heat source or by using a heat transfer medium. Here, the heat transfer medium may be glycol water or steam. The glycol water refers to a fluid obtained by mixing ethylene glycol with water. The glycol water may be heated by a medium heater (not shown) and cooled using flash gas to be circulated. In addition, the flash gas heaters 520a and 520b may heat flash gas using waste heat generated from a generator or other equipment, which is provided in a ship.

In this embodiment, as a heat transfer medium circulation line 19 passing through the gas combustion unit 510 and the flash gas heaters 520a and 520b is provided, waste heat generated from the gas combustion unit 510 using heat sources of the flash gas heaters 520a and 520b can be utilized. A heat transfer medium flowing in the heat transfer medium circulation line 19 may be glycol water, steam, or the like.

The distributor 73 of the nitrogen control unit 70 may be a three way valve or a nitrogen separator. Since the third embodiment has a configuration partially different from that of the first embodiment, their functions may be different from each other.

That is, when a ratio of nitrogen contained in flash gas supplied from the vapor-liquid separator 60 is equal to or greater than a preset ratio value, the three way valve of the third embodiment may be operated in response to a control signal of a nitrogen composition controller 72 to increase opening to the gas combustion unit 510. Accordingly, a ratio of nitrogen in a mixed gas (boil-off gas and flash gas) circulating in the system 3 can be maintained to be equal to or smaller than the preset ratio value.

In addition, when a ratio of nitrogen contained in flash gas supplied from the vapor-liquid separator 60 is equal to or greater than a preset ratio value, the nitrogen separator of the third embodiment may be operated in response to a control signal of the nitrogen composition controller 72 to separate the nitrogen such that the flash gas in which the ratio of nitrogen is reduced is joined with boil-off gas of a boil-off gas supply line 16 through a vapor recovery line 17, and the separated nitrogen is supplied to the gas combustion unit 510 through the vapor treatment line 17a. Accordingly, a ratio of nitrogen in a mixed gas (boil-off gas and flash gas) circulating in the system 3 can be maintained to be equal to or smaller than the preset ratio value.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the gas combustion unit 510.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 3, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

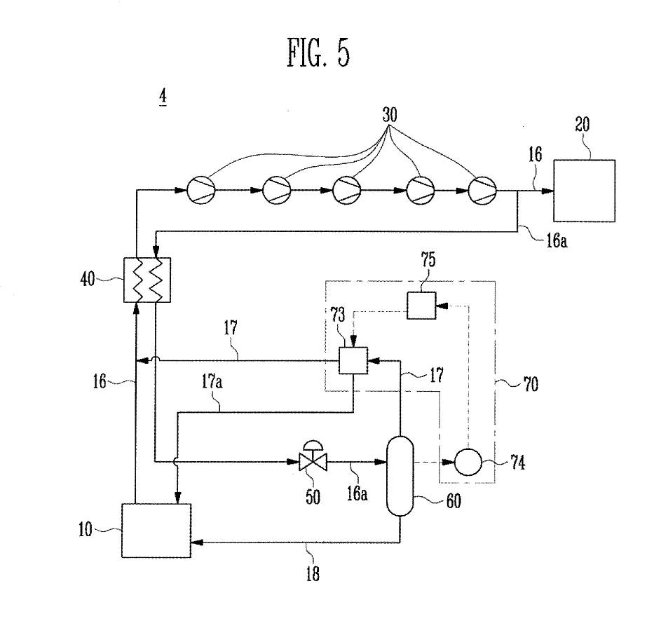

FIG. 5 is a conceptual diagram of a liquefied gas treatment system according to a fourth embodiment of the present invention.

As shown in FIG. 5, the liquefied gas treatment system 4 according to the fourth embodiment of the present invention includes a liquefied gas storage tank 10, a source 20 of demand, a boil-off gas compressor 30, a boil-off heat exchanger 40, a boil-off liquefier 50, a vapor-liquid separator 60, and a nitrogen control unit 70.

In comparison to the first embodiment, the fourth embodiment excludes the detector 71 and the nitrogen composition controller 72 from the configuration of the nitrogen control unit 70, and adds a pressure sensor 74 and a pressure control unit 75 to the configuration of the nitrogen control unit 70. The driving relationship of a distributor 73 related to the added components is different. For convenience, components identical or corresponding to those of the first embodiment of the present invention are designated by like reference numerals, and their overlapping descriptions will be omitted.

The pressure sensor 74 may be provided in the vapor-liquid separator 60. The pressure sensor 74 may detect an increase or decrease in internal pressure by measuring an internal pressure of the vapor-liquid separator 60.

The pressure sensor 74 may measure a nitrogen component of flash gas, and the nitrogen component of the flash gas may be indirectly measured by a table in which an internal pressure of the vapor-liquid separator 60 and a ratio of the nitrogen component contained in the flash gas, which corresponds thereto, are calculated by the pressure control unit 75 which will be described later.

The pressure sensor 74 may include a wired/wireless transmitting unit. The pressure sensor 74 may transmit an internal pressure of the vapor-liquid separator 60, which is analyzed as described above, to the pressure control unit 75, which will be described later, through a wired/wireless method.

The pressure control unit 75 may include a wired/wireless transmitting/receiving unit between the pressure sensor 74 and the distributor 73 which will be described later. The pressure control unit 75 may control an operation of the distributor 73, which will be described later, through a wired/wireless method by checking whether the internal pressure of the vapor-liquid separator 60, which is received from the pressure sensor 74, is equal to or smaller than or is equal to or greater than a preset pressure value.

Specifically, when an internal pressure value of the vapor-liquid separator 60 is received from the pressure sensor 74, based on a preset pressure value derived through a preset ratio value obtained by calculating a ratio of nitrogen contained in flash gas according to internal pressure of the vapor-liquid separator 60 through a table by experiment and creating a table through experiment with respect to influence, etc. on efficiency of the boil-off gas compressor 30 or stability of the system 1 according to the ratio of the nitrogen contained in the flash gas, or based on a preset pressure value obtained by creating a table through experiment with respect to influence, etc. on efficiency of the boil-off gas compressor 30 or stability of the system 1 according to the internal pressure of the vapor-liquid separator 60, the pressure control unit 75 may compare a current pressure value of the vapor-liquid separator 60, which is received from the pressure sensor 74, with the preset pressure value. When the current pressure value is equal to or smaller than the preset pressure value, the pressure control unit 75 may control an operation of the distributor 73, which will be described later, such that the flash gas is joined with boil-off gas of a boil-off supply line 16 through a vapor recovery line 17. When the current pressure value is equal to or greater than the preset pressure value, the pressure control unit 75 may control an operation of the distributor 73, which will be described later, such that at least a portion of the flash gas is supplied to the liquefied gas storage tank 10, a gas combustion unit (not shown), a nitrogen storage tank (not shown), or the like through a vapor treatment line 17a that branches off from the gas recovery line 17.

The distributor 73 may be provided on the vapor recovery line 17, be connected to the liquefied gas storage tank 10 by the vapor treatment line 17a, and be controlled in response to a control signal of the pressure control unit 75. The distributor 73 may distribute flow of flash gas such that at least a portion of the flash gas is joined with boil-off gas introduced into the boil-off gas compressor 30.

The distributor 73 may include a wired/wireless receiving unit for receiving a control signal from the pressure control unit 75. The distributor 73 may be a three way valve or a nitrogen separator.

When an internal pressure of the vapor-liquid separator 60 is equal to or greater than the preset pressure value, the three way valve may be operated in response to a control signal of the pressure control unit 75 to increase opening to the liquefied gas storage tank 10. Accordingly, a ratio of nitrogen in a mixed gas (boil-off gas and flash gas) circulating in the system 4 can be maintained to be equal to or smaller than a set value.

It will be apparent that, when the internal pressure of the vapor-liquid separator 60 is equal to or smaller than the preset pressure value, the three way valve may allow the entire or at least a portion of the flash gas to be joined with the boil-off gas.

When an internal pressure of the vapor-liquid separator 60 is equal to or greater than a preset pressure value, the nitrogen separator may be operated in response to a control signal of the pressure control unit 75 to separate the nitrogen such that the flash gas in which the ratio of nitrogen is reduced is joined with boil-off gas of the boil-off gas supply line 16 through the vapor recovery line 17, and the separated nitrogen is supplied to the liquefied gas storage tank 10, the gas combustion unit, the nitrogen storage tank, or the like through the vapor treatment line 17a. Accordingly, a ratio of nitrogen in a mixed gas (boil-off gas and flash gas) circulating in the system 4 can be maintained to be equal to or smaller than a set value.

It will be apparent that, when the internal pressure of the vapor-liquid separator 60 is equal to or smaller than the preset pressure value, the nitrogen separator is not operated to separate the nitrogen contained in the flash gas but may allow the entire or at least a portion of the flash gas to be joined with the boil-off gas.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the liquefied gas storage tank 10, the gas combustion unit, the nitrogen storage tank, or the like.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 4, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

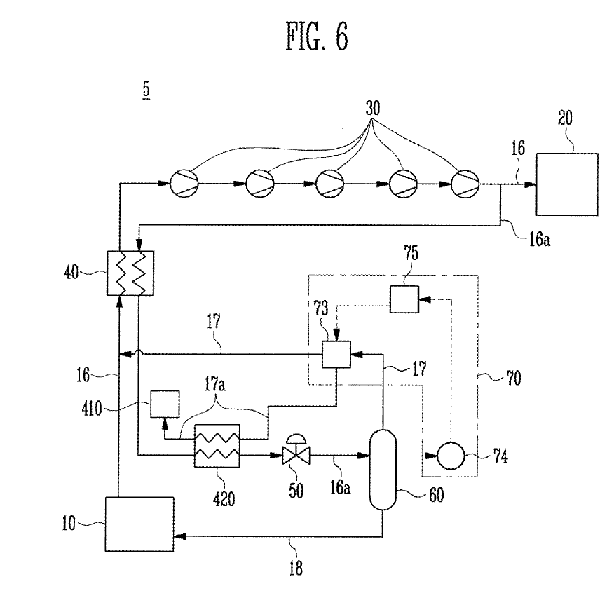

FIG. 6 is a conceptual diagram of a liquefied gas treatment system according to a fifth embodiment of the present invention.

As shown in FIG. 6, the liquefied gas treatment system 5 according to the fifth embodiment of the present invention includes a liquefied gas storage tank 10, a source 20 of demand, a boil-off gas compressor 30, a boil-off heat exchanger 40, a boil-off liquefier 50, a vapor-liquid separator 60, a nitrogen control unit 70, a source 410 of consumption, and a flash gas heat exchanger 420. In comparison to the second embodiment, the fifth embodiment excludes the detector 71 and the nitrogen composition controller 72 from the configuration of the nitrogen control unit 70, and adds a pressure sensor 74 and a pressure control unit 75 to the configuration of the nitrogen control unit 70. The driving relationship of a distributor 73 and the source 410 of consumption, which are related to the added components, is different. For convenience, components identical or corresponding to those of the first embodiment of the present invention are designated by like reference numerals, and their overlapping descriptions will be omitted.

The source 410 of consumption may be a gas combustion unit or a nitrogen storage tank. When an internal pressure of the vapor-liquid separator 60 is equal to or greater than a preset pressure value, the source 410 of consumption may treat the flash gas supplied from the vapor-liquid separator 60 through a vapor treatment line 17a such that the ratio of the nitrogen is maintained to be equal to or smaller than the preset pressure value. In this case, the vapor treatment line 17a may be connected from a distributor 73 of the nitrogen control unit 70 to the source 410 of consumption, which is a gas combustion unit or a nitrogen storage tank.

The distributor 73 of the nitrogen control unit 70 may be a three way valve or a nitrogen separator. Since the fifth embodiment has a configuration partially different from that of the second embodiment, their functions may be different from each other.

That is, when an internal pressure of the vapor-liquid separator 60 is equal to or greater than a preset pressure value, the three way valve of the fifth embodiment may be operated in response to a control signal of the pressure control unit 75 to increase opening to the flash gas heat exchanger 420 provided upstream of the source 410 of consumption. Accordingly, a ratio of nitrogen in a mixed gas (boil-off gas and flash gas) circulating in the system 5 can be maintained to be equal to or smaller than the preset ratio value, and the liquefaction efficiency of the boil-off gas for re-liquefaction can be improved. In this case, the source 410 of consumption is preferably a gas combustion unit.

In addition, when an internal pressure of the vapor-liquid separator 60 is equal to or greater than a preset pressure value, the nitrogen separator of the fifth embodiment may be operated in response to a control signal of the pressure control unit 75 to separate the nitrogen such that the flash gas in which the ratio of nitrogen is reduced is joined with boil-off gas of a boil-off gas supply line 16 through a vapor recovery line 17, and the separated nitrogen is supplied to the flash gas heat exchanger 420 provided upstream of the source 410 of consumption through the vapor treatment line 17a. Accordingly, a ratio of nitrogen in a mixed gas (boil-off gas and flash gas) circulating in the system 5 can be maintained to be equal to or smaller than the preset ratio value, and the liquefaction efficiency of boil-off gas for re-liquefaction can be improved. In this case, the source 410 of consumption is preferably a nitrogen storage tank.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the source 410 of consumption.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 5, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

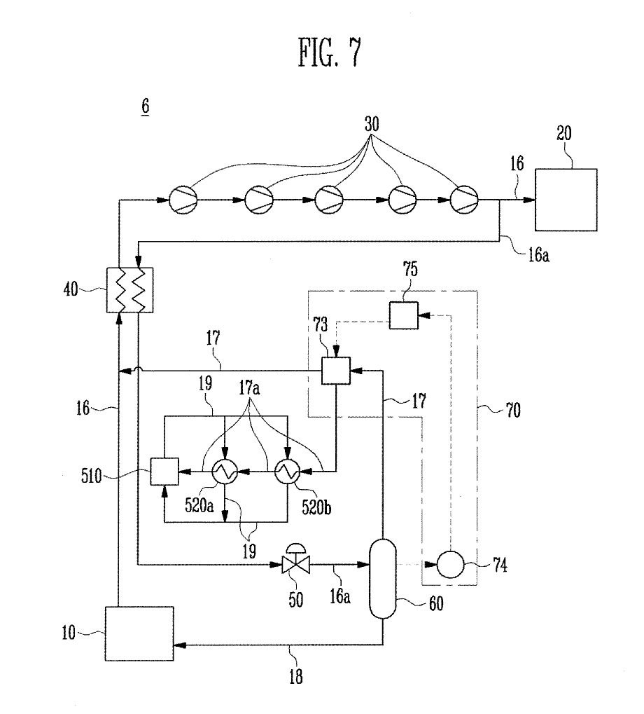

FIG. 7 is a conceptual diagram of a liquefied gas treatment system according to a sixth embodiment of the present invention.

As shown in FIG. 7, the liquefied gas treatment system 6 according to the sixth embodiment of the present invention includes a liquefied gas storage tank 10, a source 20 of demand, a boil-off gas compressor 30, a boil-off heat exchanger 40, a boil-off liquefier 50, a vapor-liquid separator 60, a nitrogen control unit 70, a gas combustion unit 510, and flash gas heaters 520a and 520b. In comparison to the third embodiment, the sixth embodiment excludes the detector 71 and the nitrogen composition controller 72 from the configuration of the nitrogen control unit 70, and adds a pressure sensor 74 and a pressure control unit 75 to the configuration of the nitrogen control unit 70. The driving relationship of a distributor 73 and the gas combustion unit 510, which are related to the added components, is different. For convenience, components identical or corresponding to those of the first embodiment of the present invention are designated by like reference numerals, and their overlapping descriptions will be omitted.

When an internal pressure of the vapor-liquid separator 60 is equal to or greater than a preset pressure value, the gas combustion unit 510 may perform combustion treatment on the flash gas supplied from the vapor-liquid separator 60 through a vapor treatment line 17a to maintain the internal pressure of the vapor-liquid separator 60 to be equal to or smaller than the preset pressure value. In this case, the vapor treatment line 17a may be connected to the distributor 73 of the nitrogen control unit 70 to the gas combustion unit 510.

Here, the gas combustion unit 510 like when the source 410 of consumption of the second embodiment is a gas combustion unit, it is required to increase the temperature of the flash gas before the flash gas is supplied to the gas combustion unit 510.

The distributor 73 of the nitrogen control unit 70 may be a three way valve or a nitrogen separator. Since the sixth embodiment has a configuration partially different from that of the third embodiment, their functions may be different from each other.

That is, when an internal pressure of the vapor-liquid separator 60 is equal to or greater than a preset pressure value, the three way valve of the sixth embodiment may be operated in response to a control signal of the pressure control unit 75 to increase opening to the gas combustion unit 510. Accordingly, a ratio of nitrogen in a mixed gas (boil-off gas and flash gas) circulating in the system 6 can be maintained to be equal to or smaller than the preset ratio value.

In addition, when an internal pressure of the vapor-liquid separator 60 is equal to or greater than a preset pressure value, the nitrogen separator of the sixth embodiment may be operated in response to a control signal of the pressure control unit 75 to separate the nitrogen such that the flash gas in which the ratio of nitrogen is reduced is joined with boil-off gas of a boil-off gas supply line 16 through a vapor recovery line 17, and the separated nitrogen is supplied to the gas combustion unit 510 through the vapor treatment line 17a. Accordingly, a ratio of nitrogen in a mixed gas (boil-off gas and flash gas) circulating in the system 6 can be maintained to be equal to or smaller than the preset ratio value.

Here, the preset ratio value of the ratio of the nitrogen refers to a case where an accumulated ratio of the nitrogen in the boil-off gas is 20% to 40% (preset ratio value). When the accumulated ratio of the nitrogen in the boil-off gas is 20% to 40% (preset ratio value), the distributor 73 may separate nitrogen from the flash gas to supply the nitrogen to the gas combustion unit 510.

In this embodiment, as the ratio of nitrogen accumulated in boil-off gas is not converged to 40% to 60%, methane (CH₄) in the boil-off gas is chemically matted by the nitrogen not to be re-liquefied, and circulates in gaseous state in the liquefied gas treatment system 6, so that it is possible to prevent re-liquefaction efficiency of the boil-off gas from being rapidly deteriorated.

In addition, in this embodiment, as the ratio of nitrogen accumulated in boil-off gas is not converged to 40% to 60%, increase in compression work of the boil-off gas compressor 30 can be prevented, and accordingly, increase in shaft power of the boil-off gas compressor 30 can be prevented.

As described above, in this embodiment, as the internal pressure of the vapor-liquid separator 60 is controlled to be equal to or smaller than the preset pressure value, the nitrogen having a predetermined mass flow or higher is supplied to the boil-off gas compressor 30, so that recycle control can be minimized, thereby improving driving efficiency. In addition, the ratio of nitrogen in the system 1 to 6 can be properly controlled. Accordingly, the efficiency of the boil-off gas compressor 30 can be improved, and the system 1 to 6 can be stabilized. When the internal pressure of the vapor-liquid separator 60 is equal to or greater than the preset pressure value, at least a portion of the flash gas is controlled to be supplied to the liquefied gas storage tank 10 to maintain the internal pressure of the vapor-liquid separator 60 to be equal to or smaller than the preset pressure value, so that the flash gas can stored and treated in the liquefied gas storage tank 10. Accordingly, environmental pollution due to discharging of the flash gas to the air can be prevented, and boil-off gas can be well supplied by increasing internal pressure of the liquefied gas storage tank 10.

While the present invention has been described with respect to the specific embodiments, this is for illustrative purposes only, and the present invention is not limited thereto. Therefore, it will be apparent to those skilled in the art that various changes and modifications may be made within the technical spirit and scope of the present invention.

Accordingly, simple changes and modifications of the present invention should also be understood as falling within the present invention, the scope of which is defined in the appended claims and their equivalents.

### PATENT DOCUMENTS

(Prior Document 1) Korean Registered Patent No. 10-1289212 (Publication Date: Jul. 29, 2013)

(Prior Document 2) Korean Patent Laid-open Publication No. 10-2011-0118604 (Publication Date: Oct. 31, 2011)

1. A liquefied gas treatment system comprising:
a boil-off gas compressor configured to pressurize boil-off gas supplied from a liquefied gas storage tank;
a boil-off gas liquefier configured to liquefy at least a portion of the boil-off gas pressurized by the boil-off gas compressor,
a vapor-liquid separator configured to separate flash gas from the boil-off gas liquefied by the boil-off gas liquefier and mix at least a portion of the flash gas with the boil-off gas; and
a nitrogen control unit configured to control a content of nitrogen in the boil-off gas or the flash gas, when a ratio of a nitrogen component of the flash gas is equal to or greater than a preset value.

2. The liquefied gas treatment system of claim 1, further comprising a boil-off gas heat exchanger configured to exchange heat between the boil-off gas pressurized by the boil-off gas compressor and the boil-off gas supplied from the liquefied gas storage tank.

3. The liquefied gas treatment system of claim 2, further comprising a flash gas heat exchanger configured to exchange heat between the boil-off gas pressurized by the boil-off gas compressor and the flash gas,
wherein the nitrogen control unit includes:
a detector configured to analyze and detect components of the flash gas generated from the vapor-liquid separator,
a distributor configured to distribute flow of the flash gas to allow at least a portion of the flash gas to be joined with the boil-off gas introduced into the boil-off gas compressor; and
a nitrogen composition controller configured to control an operation of the distributor by checking whether a ratio of a nitrogen component in the components of the flash gas, which are received from the detector, is equal to or smaller than or is equal to or greater than a preset ratio value.

4. The liquefied gas treatment system of claim 3, wherein the nitrogen composition controller:
compares a current ratio value of the nitrogen component in the components of the flash gas, which are received from the detector, with the preset ratio value;
when the current ratio value is equal to or smaller than the preset ratio value, controls the operation of the distributor to allow the flash gas to be joined with the entire or at least a portion of the boil-off gas; and
when the current ratio value is equal to or greater than the preset ratio value, controls the operation of the distributor to allow the nitrogen component separated from the flash gas to be supplied to the flash gas heat exchanger,
wherein, when a ratio of nitrogen contained in the flash gas supplied from the vapor-liquid separator is equal to or greater than a preset ratio value, the distributor separates the nitrogen in response to a control signal of the nitrogen composition controller to allow the flash gas in which the nitrogen is reduced to be joined with the boil-off gas, and supplies the separated nitrogen to the flash gas heat exchanger.

5. The liquefied gas treatment system of claim 2, further comprising a flash gas heat exchanger configured to exchange heat between the boil-off gas pressurized by the boil-off gas compressor and the flash gas,
wherein the nitrogen control unit includes:
a detector configured to measure and detect an internal pressure of the vapor-liquid separator;
a distributor configured to distribute flow of the flash gas to allow at least a portion of the flash gas to be joined with the boil-off gas introduced into the boil-off gas compressor, and
a nitrogen composition controller configured to control an operation of the distributor by checking whether the internal pressure of the vapor-liquid separator, which is received from the detector, is equal to or smaller than or is equal to or greater than a preset pressure value.

6. The liquefied gas treatment system of claim 5, wherein the nitrogen composition controller:
compares a current pressure value of the internal pressure of the vapor-liquid separator, which is received from the detector, with the preset pressure value;
when the current pressure value is equal to or smaller than the preset pressure value, controls the operation of the distributor to allow the entire or at least a portion of the flash gas to be joined with the boil-off gas; and
when the current pressure value is equal to or greater than the preset pressure value, controls the operation of the distributor to allow the nitrogen component separated from the flash gas to be supplied to the flash gas heat exchanger,
wherein, when a ratio of nitrogen contained in the flash gas supplied from the vapor-liquid separator is equal to or greater than a preset ratio value, the distributor separates the nitrogen in response to a control signal of the nitrogen composition controller to allow the flash gas in which the nitrogen is reduced to be joined with the boil-off gas, and supplies the separated nitrogen to the flash gas heat exchanger.

7. The liquefied gas treatment system of claim 1, wherein the nitrogen control unit allows a portion of the rest of the flash gas to be discharged to a gas combustion unit.

8. The liquefied gas treatment system of claim 7, further comprising a flash gas heater configured to heat the flash gas discharged to the gas combustion unit using waste heat generated from the gas combustion unit,
wherein the nitrogen control unit includes:
a detector configured to analyze and detect components of the flash gas generated from the vapor-liquid separator,
a distributor configured to distribute flow of the flash gas to allow at least a portion of the flash gas to be joined with the boil-off gas introduced into the boil-off gas compressor; and
a nitrogen composition controller configured to control an operation of the distributor by checking whether a ratio of a nitrogen component in the components of the flash gas, which are received from the detector, is equal to or smaller than or is equal to or greater than a preset ratio value.

9. The liquefied gas treatment system of claim 8, wherein the nitrogen composition controller:
compares a current ratio value of the nitrogen component in the components of the flash gas, which are received from the detector, with the preset ratio value;
when the current ratio value is equal to or smaller than the preset ratio value, controls the operation of the distributor to allow the flash gas to be joined with the entire or at least a portion of the boil-off gas; and
when the current ratio value is equal to or greater than the preset ratio value, controls the operation of the distributor to allow the nitrogen component separated from the flash gas to be supplied to the gas combustion unit,
wherein, when a ratio of nitrogen contained in the flash gas supplied from the vapor-liquid separator is equal to or greater than a preset ratio value, the distributor separates the nitrogen in response to a control signal of the nitrogen composition controller to allow the flash gas in which the nitrogen is reduced to be joined with the boil-off gas, and supplies the separated nitrogen to the gas combustion unit.

10. The liquefied gas treatment system of claim 7, further comprising a flash gas heater configured to heat the flash gas discharged to the gas combustion unit using waste heat generated from the gas combustion unit,
wherein the nitrogen control unit includes:
a detector configured to measure and detect an internal pressure of the vapor-liquid separator;
a distributor configured to distribute flow of the flash gas to allow at least a portion of the flash gas to be joined with the boil-off gas introduced into the boil-off gas compressor; and
a nitrogen composition controller configured to control an operation of the distributor by checking whether the internal pressure of the vapor-liquid separator, which is received from the detector, is equal to or smaller than or is equal to or greater than a preset pressure value.

11. The liquefied gas treatment system of claim 10, wherein the nitrogen composition controller:
compares a current pressure value of the internal pressure of the vapor-liquid separator, which is received from the detector, with the preset pressure value;
when the current pressure value is equal to or smaller than the preset pressure value, controls the operation of the distributor to allow the entire or at least a portion of the flash gas to be joined with the boil-off gas; and
when the current pressure value is equal to or greater than the preset pressure value, controls the operation of the distributor to allow the nitrogen component separated from the flash gas to be supplied to the gas combustion unit,
wherein, when a ratio of nitrogen contained in the flash gas supplied from the vapor-liquid separator is equal to or greater than a preset ratio value, the distributor separates the nitrogen in response to a control signal of the nitrogen composition controller to allow the flash gas in which the nitrogen is reduced to be joined with the boil-off gas, and supplies the separated nitrogen to the gas combustion unit.

12. The liquefied gas treatment system of claim 2, further comprising a mixer provided upstream of the boil-off gas heat exchanger, the mixer being configured to mix flash gas recovered from the vapor-liquid separator with the boil-off gas supplied from the liquefied gas storage tank and supply the mixed gas to the boil-off gas heat exchanger.
